(19) United States
(12) Patent Application Publication
(10) Pub. No.: US 2026/0340679 A1
(43) Pub. Date: Oct. 29, 2026

(54) ARBITRATION SYSTEM IN A NETWORK ENVIRONMENT

(71) Applicant: Walmart Apollo, LLC, Bentonville, AR (US)

(72) Inventors: Abhimanyu Mitra, Cupertino, CA (US); Evren Korpeoglu, San Jose, CA (US); Kannan Achan, Saratoga, CA (US); Rahul Radhakrishnan Iyer, Sunnyvale, CA (US); Zhihao Huang, Hayward, CA (US); Shashank Kedia, Sunnyvale, CA (US); Mansi Ranjit Mane, Santa Clara, CA (US); Linju Aranjaniyil R, Santa Clara, CA (US); Afroza Ali, Los Altos, CA (US); Hyun Duk Cho, San Francisco, CA (US); Rajagopal Reddy Manda, Newark, CA (US); Sushant Kumar, San Jose, CA (US); Topojoy Biswas, Pleasanton, CA (US); Vamsi Mohan Srinivasa Muddada, Bellevue, WA (US)

(21) Appl. No.: 19/193,766

(22) Filed: Apr. 29, 2025

(51) Int. Cl. G06Q 30/0251; G06Q 30/0241

(52) U.S. Cl. CPC G06Q 30/0254; G06Q 30/0277

(57) ABSTRACT

Example implementations relate to content item selection in a network environment. In an example, a plurality of categories of content for display in a network environment and a corresponding performance parameter for each of the plurality of categories of content are received. A metric for each of the plurality of categories of content is generated, an allocation for each of the plurality of categories of content based on the metric and a selected distribution for the allocation is generated. The allocation to obtain an updated allocation based on a target parameter and a current parameter of the corresponding performance parameter associated with a respective category of content of the plurality of categories of content is adjusted. A content item from a category of content having a highest updated allocation is selected, and a user interface that displays the selected content item in the network environment is automatically generated.

### TECHNICAL FIELD

This application relates generally to automated content item selection, and more particularly, to automated content item selection in network environments.

### BACKGROUND

Network interfaces, such as social media, fitness, news, logistics, delivery and e-commerce interfaces, can present different content items to a user. Due to limited space on a content page of the network interface, it may be challenging to manually or statically select content items for display that balance multiple competing objectives associated with the different content items while providing an optimal combination of different content items. A user may feel overwhelmed when multiple content items are displayed or pushed to the user at the same time, which may result in confusion and frustration, and may undermine the user's experience on the network interface. In addition, the dynamic nature of the traffic flow to the content page and the variation in the pool of candidate content items may pose additional challenges to determining the optimal combination of content items for display to a user. Furthermore, the multiple competing objectives to be balanced may be specified at an aggregated level while the selection of content items for display to a user is made on a more granular or individual level. Thus, it may be challenging to ensure that objectives at an aggregated level are achieved based on the performance of multiple granular level selection.

### BRIEF DESCRIPTION OF THE DRAWINGS

Various examples will be described below with reference to the following figures.

FIG. 1 is a block diagram of an example content item selection system that includes an arbitration system in accordance with some embodiments.

FIG. 2 is a block diagram of two example content layouts in accordance with some embodiments.

FIG. 3 is a block diagram of an example content item selection system that includes arbitration system in accordance with some embodiments.

FIG. 4 is a flowchart illustrating an example arbitration method in accordance with some embodiments.

FIG. 5 is a flowchart illustrating an example content item selection method that includes an arbitration method in accordance with some embodiments.

FIG. 6 is an example machine-readable storage medium in accordance with some embodiments.

FIG. 7 depicts an example computer system that implements one or more of the disclosed processes in accordance with some embodiments.

### DETAILED DESCRIPTION

The disclosed systems and methods provide a content item selection process that utilizes an arbitration system to automatically select an optimal combination of content items to be presented to a user that balances multiple competing objectives in a network environment. For example, the network environment may include a platform on which users may disclose and/or receive information (e.g., fitness, news, logistics, delivery, or other types of information), interact via social media, list items for sale, and/or buy items offered by sellers.

Personalizing content items to be displayed to a user on a content page (e.g., hereinafter a “content page” may refer to a webpage, an email, a push notification, or content display on another communication channel) may include determining a layout for displaying the selection of content items and/or selecting content items that optimize a metric (e.g., a user feedback metric or a business metric). For example, the metric may measure how much user engagement a content item generates on the content page, such as a click through rate (CTR), which is a ratio of the number of clicks on content items over a total number of content items presented to the user.

In practice, multiple goals may have to be balanced through the display of a selection of content items. For example, displaying content items that are more relevant to a user may keep the user satisfied with the user experience on the network interface, but other content items which may not be displayed based on relevance to the user may be displayed to generate revenue for operating the network interface. Assigning different slots on a content page to different objectives through ad-hoc analytics and business alignment before invoking personalization algorithms may thus result in a suboptimal selection of content items. Such a manual mechanism may also be time-consuming and suboptimal since it uses an undifferentiated approach to make a universal slot allocation for a single objective for all users. For example, if one content item slot is allocated to increasing a third-party platform engagement and third-party platform engagement content items are shown to a customer who has no interest in the content items offered, the content item slot may be wasted. An alternative approach may include using the content item slot for other content items the customer is interested in. A universal slot allocation to a particular performance or business objective may not be dynamically adjusted based on imbalances in attainments of specified performance goals. Moreover, even after imbalances are identified manually, such a slot allocation system may be inflexible and may require a large amount of manual effort and time to adapt to changes in business or performance priorities.

In contrast to standard multi-objective optimization frameworks which may directly optimize a specified performance metric (e.g., CTR, add-to-cart, or another metric), a content selection system may have less control over the specified performance metric that is to be optimized. For example, the specified performance metric may relate to optimizing objectives such as increasing an amount of user interaction (e.g., increasing the CTR or add-to-cart) or increasing conversion (e.g., a user purchasing an item that is added to a cart, or another metric), and the variable available for the content selection system to optimize is the selection of which content items to be displayed to a user and not directly optimizing for increased user interactions or conversation. In some embodiments, while a probability and/or a conversion probability may be estimated for each content item, such predictions are dependent on the user and the context in which the content item is presented. In some embodiments, the content item selection system may not control which user would be visiting a content page on which the arbitration system is activated, or what context the user would be encountering the selected content items, making the task of accurately predicting the types of clicks and/or conversion that may be achieved from a particular visit by a user more challenging.

Further, while objective targets (e.g., business targets for a customer-associated metric) may be provided at an aggregate level, the content item selection system may be used to select content items at a more granular level (e.g., for each user on each page visit) by making more granular prediction for each page visit such that the behavior of an aggregated flow of users to one or more content pages meets objective targets for aggregated performance metrics. In some embodiments, the disclosed content item selection system includes a more dynamic arbitration system due to the traffic pattern to a content page fluctuating and/or changing more quickly than optimization solutions offered by standard multi-objective optimization techniques.

Systems that rely on an optimization function that uses a weighted sum of performance metrics may not be able to control a distribution of individual performance metrics within the weighted sum. As a result, a weighted sum of customer metrics may be more likely to provide an output that is skewed toward a subset (e.g., a single metric, or just a small subset) of the performance metrics, which may result in an unacceptable outcome in practice (e.g., some metrics that are below an acceptable minimum level of performance). In some instances, due to the highly dynamic traffic pattern and the pool of candidate content items in an application setting (e.g., an ecommerce setting, or other content delivery settings), a static weight multiplier to a metric in a weight sum of metrics may not be suitable. For example, a static weight multiplier may not be adapted to dynamically adjust to a different (e.g., a richer) content pool that results in one or more metric changing (e.g., moving higher), and may require adjustments to the weight multiplier to be made to correct a balance among the metrics if the updated content pool has no impact on the other metrics under consideration. A similar effect may arise due to dynamic changes in traffic pattern of visitors to the content page.

In various embodiments, a system including a processor and a non-transitory memory storing instructions is disclosed. The instructions, when executed, cause the processor to receive a plurality of categories of content for display in a network environment and corresponding performance parameter for each of the plurality of categories of content within the network environment to arbitrate one or more content items from the plurality of categories of content to be displayed in the network environment. The instructions further cause the processor to generate a metric for each of the plurality of categories of content. The instructions further cause the processor to generate an allocation for each of the plurality of categories of content based on the metric and a selected distribution for the allocation. The instructions further cause the processor to adjust the allocation to obtain an updated allocation based on a target parameter and a current parameter of the corresponding performance parameter associated with a respective category of content of the plurality of categories of content. The instructions further cause the processor to select, by arbitrating based on updated allocations of the one or more content items from the plurality of categories of content, a content item from a category of content having a highest updated allocation. The instructions further cause the processor to automatically generate a user interface within the network environment that displays the selected content item

In various embodiments, a computer-implemented method is disclosed. The computer-implemented method includes steps of receiving a plurality of categories of content for display in a network environment and a corresponding performance parameter for each of the plurality of categories of content within the network environment to arbitrate one or more content items from the plurality of categories of content to be displayed in the network environment. The computer-implemented method further includes a step of generating a metric for each of the plurality of categories of content. The computer-implemented method further includes a step of generating an allocation for each of the plurality of categories of content based on the metric and a selected distribution for the allocation. The computer-implemented method further includes a step of adjusting the allocation to obtain an updated allocation based on a target parameter and a current parameter of the corresponding performance parameter associated with a respective category of content of the plurality of categories of content. The computer-implemented method further includes a step of selecting, by arbitrating based on updated allocations of the one or more content items from the plurality of categories of content, a content item from a category of content having a highest updated allocation. The computer-implemented method further includes a step of automatically generating a user interface within the network environment that displays the selected content item.

In various embodiments, a non-transitory computer-readable medium having instructions stored thereon is disclosed. The instructions, when executed by at least one processor, cause at least one device to perform operations including receiving a plurality of categories of content for display in a network environment and a corresponding performance parameter for each of the plurality of categories of content within the network environment to arbitrate one or more content items from the plurality of categories of content to be displayed in the network environment. The instructions further cause the at least one device to perform operations including generating a metric for each of the plurality of categories of content. The instructions further cause the at least one device to perform operations including generating an allocation for each of the plurality of categories of content based on the metric and a selected distribution for the allocation. The instructions further cause the at least one device to perform operations including adjusting the allocation to obtain an updated allocation based on a target parameter and a current parameter of the corresponding performance parameter associated with a respective category of content of the plurality of categories of content. The instructions further cause the at least one device to perform operations including selecting, by arbitrating based on updated allocations of the one or more content items from the plurality of categories of content, a content item from a category of content having a highest updated allocation. The instructions further cause the at least one device to perform operations including automatically generating a user interface within the network environment that displays the selected content item.

This description of the example embodiments is intended to be read in connection with the accompanying drawings that are to be considered part of the entire written description. Terms concerning data connections, coupling and the like, such as “connected,” “interconnected,” and/or “in signal communication with” refer to a relationship wherein systems or elements are electrically connected (e.g., wired, wireless) to one another, either directly or indirectly, through intervening systems, unless expressly described otherwise. The term “operatively coupled” is such a coupling or connection that enables the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

A content item selection system, as described herein in some embodiments, may function as a recommendation system for selecting a set of content items that that would be presented to a user and are expected to achieve various performance objectives. Selecting content items from a wide range of heterogeneous content items may be challenging due to the varied nature of the content items, and the competing objectives associated with the content items such a selection system may have to handle. A consolidated framework for automatically selecting an optimized set of content items across a range of heterogeneous content may help to better meet various competing performance objectives associated with the content items, and may thereby help to reduce a likelihood of a user having a fragmented user experience in the network environment with respect to the different content items.

Furthermore, in the following, various embodiments are described with respect to methods and systems for content item selection. In various embodiments, the methods and systems described herein can use a machine learning model to learn representations of various user features associated with a user of a network environment. In some embodiments, the content item selection system uses a state, action and reward driven approach to optimize the selection of content items across competing objectives. For example, the content item selection system analyzes a user's interaction within a content display environment (e.g., an ecommerce environment, a social media environment, a networking environment, and/or other interaction environments in which information is displayed via one or more communication channels). In some embodiments, the content item selection system analyzes a user's interaction with the content display environment includes understanding a user's journey (e.g., the user's prior interactions with the content display environment, or a chronology of the user's prior interactions with one or more webpages or applications, and/or operations performed by the user in the content display environment), and deduces an intent of the user associated with a particular interaction session with the content display environment.

In some embodiments, the content item selection system analyzes a user's preferences (e.g., usage preferences and/or other affinities), determine whether the user is a new user or a returning user, a geo-location of the user, user demographics, referral performed by or received by the user, whether the user subscribes to any membership associated with the content display environment, information about ownership status (e.g., car ownership etc.) associated with the user, information about the eligibility of the user to join loyalty programs associated with the content display environment, the page type, season and/or information regarding a device with which the user is accessing the content display environment.

In some embodiments, the content item selection system analyzes the user's past interaction or operations with the content display environment (e.g., browsing pattern, current/previous session interaction, purchases, return/cancellation experiences, predictive basket, fulfillment, cross-pollination, interactions with a third-party ecommerce platform).

In some embodiments, the arbitration system may arbitrate between different types or categories of content items (e.g., heterogeneous content). For example, on a content page that is home page, the content may include a grid arrangement of content items, a section of content items that extends across a webpage, display of advertisement, a grid of items from different departments associated with an ecommerce environment (e.g., apparel, devices, home goods, food, tools, etc.). These different types or categories of content items may also be referred hereinafter as “heterogeneous content,” in view of their diverse and distinct nature. The heterogeneous content may be associated with different objectives and/or incentives. In some embodiments, the disclosed arbitration system may convert all these objectives to a single common metric to more fairly and efficiently maximize the overall/aggregated objective (e.g., utility or another parameter).

In some embodiments, after analyzing and understanding the user, a context state of the user, the heterogeneous content items available for display to the user, the content item selection system identifies an action space that includes possible actions the content item selection system and/or the user can take based on the analysis about features of the user and the context state of the user, improving the relevance of the displayed content items to the user, and may help improve user experience and/or ease of performing various interactions (e.g., transactions) in the network environment.

The content element selection systems and methods described herein, in some embodiments, may also be able to improve the relevance and consistency of the content items that are presented to the user, while balancing multiple, optionally competing, objectives. Although specific embodiments discussed herein include content items related to interactions with a network environment, it will be appreciated that any content items for interaction with any suitable platform can be identified as a recommended content item to be displayed according to the disclosed systems and methods.

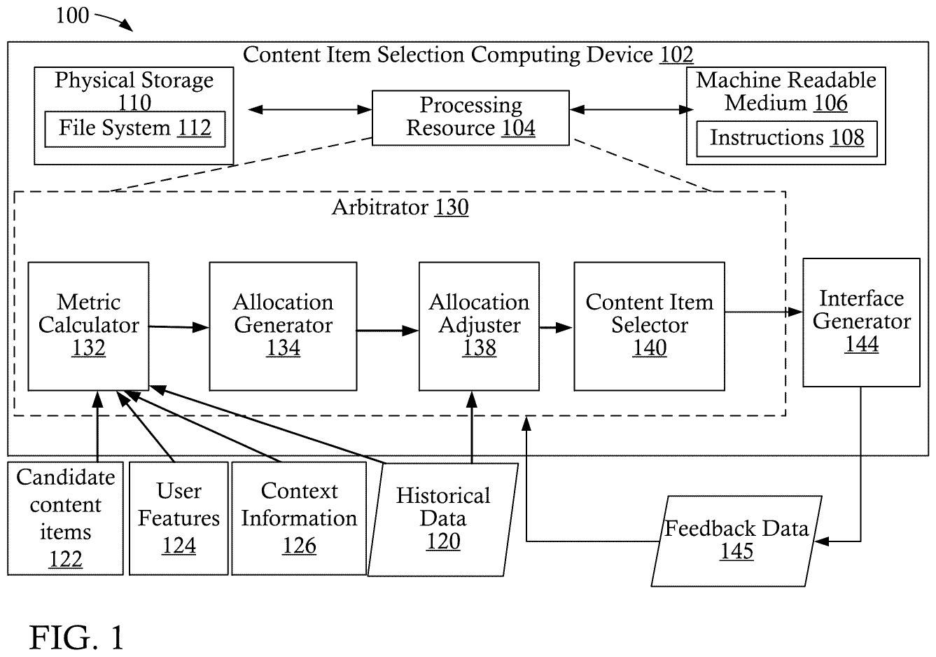

FIG. 1 depicts an example system 100 that implements an arbitration engine for content item selection, in accordance with some embodiments. System 100 includes a content item selection computing device 102 that selects one or more content items to be displayed to a user. The content item selection computing device 102 includes a processing resource 104 that may include one or more microcontrollers, microprocessors, field-programmable gate arrays (FPGAs), application-specific integrated circuits (ASICs), state machines, digital circuitry, and/or any other suitable processing resource. The content item selection computing device 102 includes a non-transitory machine-readable medium 106 that may include one or more of a random-access memory (RAM), read-only memory (ROM), electrically erasable programmable read-only memory (EEPROM), flash memory, hard disk, and/or any other suitable memory resource.

In some embodiments, the content item selection computing device 102 selects a content item to be presented (e.g., displayed on a user interface) to a user. The processing resource 104 may execute instructions 108 (i.e., programming or software code) stored on machine readable medium 106 to perform functions of the content item selection computing device 102, such as receiving a plurality of categories of content and corresponding performance parameter for each of the plurality of categories of content, generating a metric for each of the plurality of categories of content, generating an allocation for each of the plurality of categories of content based on the metric and a selected distribution for the allocation, adjusting the allocation to obtain an updated allocation based on a target parameter and a current parameter of the corresponding performance parameter associated with a respective category of content of the plurality of categories of content, selecting a content item from a category of content having a highest updated allocation, and automatically generating a user interface that displays the selected content item.

For example, the generation of an allocation, or an adjustment of the allocation to obtain an updated allocation based on a target parameter described below may include adjustments of weights to an optimization function of a reinforcement learning model that is a part of the model training for the reinforcement learning model. During the model training, the weights provide different levels of attention to different historical user data point based on user groupings. The instructions 108 may include instructions for implementing one or more models. In some embodiments, and as will be described further herein below, the content item selection computing device 102 may execute one or more models, processes, or algorithms, such as a machine learning model, deep learning model, statistical model, etc., (e.g., implemented as machine readable instructions), to select a content item.

The content item selection computing device 102 may also include other hardware components, such as physical storage 110. Physical storage 110 may include any physical storage device, such as a hard disk drive, a solid-state drive, or the like, or a plurality of such storage devices (e.g., an array of disks), and may be locally attached (e.g., installed) in the content item selection computing device 102. In some implementations, physical storage 110 may be accessed as a block storage device.

In some cases, the content item selection computing device 102 may also include a local file system 112 that may be implemented as a layer on top of the physical storage 110. For example, an operating system may be executing on the content item selection computing device 102 (by virtue of the processing resource 104 executing certain instructions 108 related to the operating system) and the operating system may provide a file system 112 to store data on the physical storage 110.

The content item selection computing device 102 may be in communication with one or more additional devices over one or more network channels. For example, in various embodiments, the content item selection computing device 102 may be in communication with a web server, a cloud-based engine including one or more processing devices that may be provisioned for use, a database, a workstation, and/or any other suitable system or device. The content item selection computing device 102 may similarly be in communication, either directly or indirectly, with one or more user computing devices operatively coupled over the network. The other computing systems may be similar to the content item selection computing device 102 and may each include at least a processing resource and a machine-readable medium.

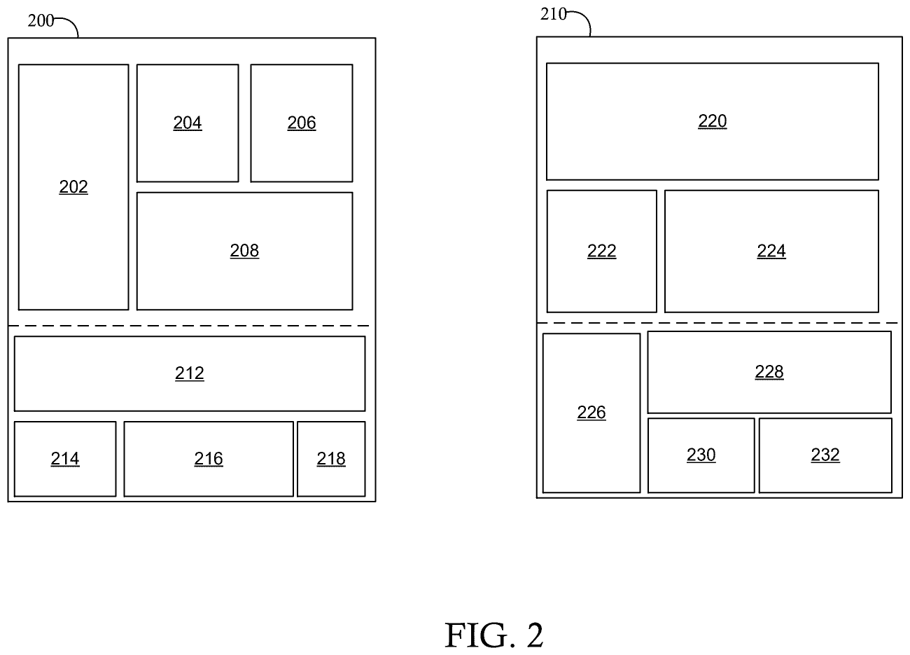

In some embodiments, in contrast to providing a single optimizer for all users (e.g., a visitor to a content page) to score all eligible content items that may be presented to the user (e.g., the score accounts for optimizing a particular metric assigned to the optimizer) at a particular content item slot (e.g., explained in detail with respect to FIG. 2) on a webpage, email, or another communication channel, the content item selection computing device 102 provides multiple optimizers for a single content item slot, each of the multiple optimizers is associated with a target metric for a performance parameter of a different performance parameter or objective (e.g., a bounce rate, an amount of user engagement, repeat engagement, number of add-to-cart, conversion, gross value of merchandise, cross sell, cross pollination, revenue from displaying content items, retention, lifetime value, or another metric). For example, instead of specifying that a particular content item slot is reserved for a specific type or category of content (e.g., for a particular objective) and using a single optimizer to optimize for a specific metric associated with that type or category of content (e.g., optimizes the metric for content items within a specific list of eligible content items from different lists of eligible content items associated with the different types or categories of contents), the content item selection computing device activates multiple optimizers each optimizing for a different objective.

In some embodiments, the content item selection computing device 102, such as the processing resource 104, includes an arbitrator 130 that implements a metric calculator 132, an allocation generator 134, an allocation adjuster 138, and a content item selector 140. In some embodiments, the metric calculator 132 receives candidate content items of one or more types or categories, and a corresponding performance parameter for each of the types or categories of content items. For example, the different types and categories of content may relate to different performance parameters, such as content items for increasing subscription to an enrollment program, increasing a level of interaction with a third-party ecommerce platform, increasing revenue generated from sales on an ecommerce platform, increasing revenue generated by displaying content items (e.g., advertisements) on a content display system, and/or other objectives. In some embodiments, for each type or category of content item slot, the arbitrator 130 is activated and receives from each of the multiple optimizers a conversion of the metric or the score into an allocation (e.g., a bid, or another allocation of specific resources). In some embodiments, the arbitrator 130 may specify a distribution of acceptable allocations (e.g., allocations provided by each of the multiple optimizers are to conform to a distribution having a specified expectation value and/or variance). Such an approach may allow the content item selection system to compare between different objectives and select a combination of content items for various content item slots on a webpage, email or another communication channel that optimize an aggregated set of objectives.

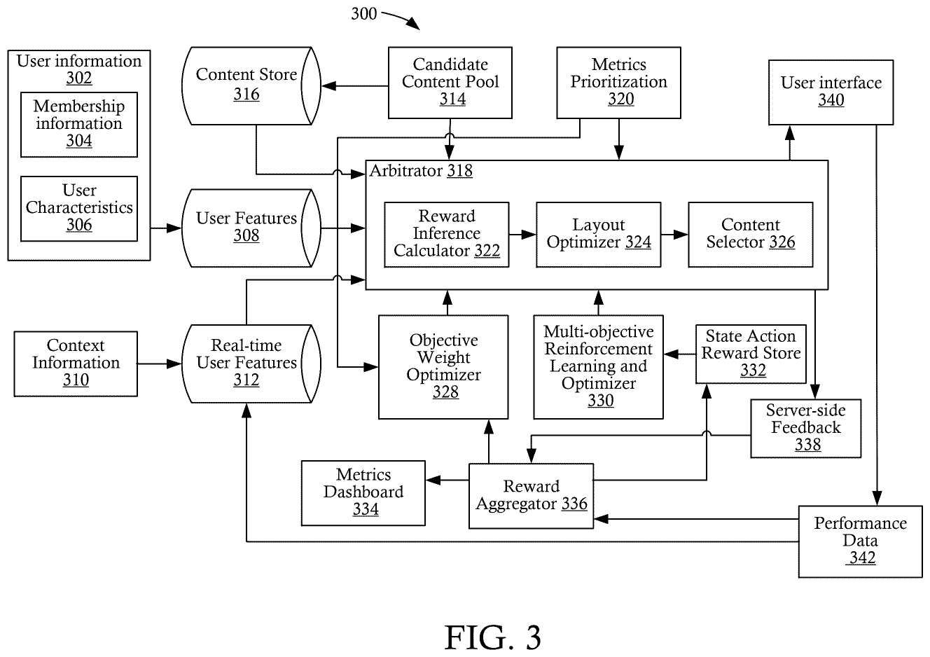

In some embodiments, the metric calculator 132 generates (e.g., computes, and/or calculates) a metric associated with a respective candidate content item from the candidate content items 122, user features 124, context information 126, and historical data 120. In some embodiments, the metric is a reward score (e.g., interchangeably referred to hereinafter as “reward,” “score,” “raw score,” and/or “raw reward score”), such as a score Rᵢ(U, C, X) for an i-^{th} reward generated by each of the multiple optimizers that optimize for an i-^{th} reward for a user U (e.g., having the user features 124), content C (e.g., from the candidate content items 122), and context X (e.g., from the context information 126). In some embodiments, the historical data 120, which may include observed traffic from a previous time interval (e.g., the past x weeks, the past x months, the past x days), content items of different categories that were displayed at respective positions on a content page, and allocations (e.g., bids, top winning bids, and/or top non-winning bids) associated with content items of different categories may be used to generate a normalized metric score that allows the metric scores to be dynamically adjusted with respect to traffic flow and the candidate content pool. Further description of the metric calculator 132 is provided with reference to FIG. 3.

In some embodiments, the allocation generator 134 converts the calculated score Rᵢ(U, C, X), from each of the multiple optimizers using an allocation distribution specified by the arbitrator 130, to an allocation ƒᵢ(Rᵢ(U, C, X)), where the function ƒᵢ is a non-decreasing function determined and/or selected by each of the multiple optimizers and/or the allocation generator 134. In some embodiments, the arbitrator 130 specifies the distribution of the allocation ƒᵢ(Rᵢ(U, C, X)) that is to be satisfied by each of the multiple optimizers for all i. As an example, the arbitrator 130 may be used to select an order of recommendation slots (e.g., modules or other content formats) to be presented on a webpage. In such scenarios, U corresponds to the user visiting the webpage, X corresponds to the webpage, and C correspond to the recommendation content items corresponding to the recommendation slots. A possible distribution of the allocation ƒᵢ(Rᵢ(U, C, X)) specified by the arbitrator 130 in such a scenario may be:

E_{{U visits webpage X and observes c}}[ƒᵢ(Rᵢ(U,C,X))]=0

Var_{{U visits webpage X and observes C}}[ƒᵢ(Rᵢ(U,C,X))]=1

where E denotes the expectation and Var denotes the variance. The arbitrator 130 may apply different distributions of allocations for any time period, and the same distribution of allocations is placed on each of the multiple optimizers to ensure fair arbitration between competing objectives.

In some embodiments, the arbitrator 130 is enabled to specify the allocation distributions for the sets of allocations the arbitrator 130 arbitrates for a particular optimizer. For example, if the arbitrator 130 arbitrates content items for a first optimizer on a first webpage, the arbitrator 130 may only apply a specified allocation distribution on the allocations made by the first optimizer on that first webpage. In contrast, in some embodiments, a centralized arbitrator may be enabled to view allocations for the same first optimizer over multiple webpages and/or multiple content item slots, and may be enabled to impose additional requirements on the allocation distributions (e.g., allocation distribution across different webpages, allocation for different types or categories of content item slots) for the first optimizer compared to an arbitrator that arbitrates between different content items on a single webpage.

In some embodiments, after the arbitrator 130 receives the allocations, which satisfy the allocation distribution specified by the arbitrator 130, from each of the multiple optimizers for each of the eligible content items, an allocation adjuster 138 of the arbitrator 130 compares a specific target Tₙ (e.g., a business target, and/or a target associated with an objective) assigned to each optimizer n, a current attainment tₙ, and the allocation adjuster 138 adjusts the allocations based on the set of specific targets:

dₙ(U, C, X)=gₙ({(Tₙ, tₙ), n=1, 2, . . . N}, ƒᵢ(Rᵢ(U, C, X)))

where N is the number of optimizers competing for content item slots.

In some embodiments, the adjustments the allocation adjuster 138 makes on the allocation of the optimizer n is independent of the allocation distributions of the other optimizers. As an example, the function gₙ(·) may be:

$${g}_{n} ( \{ ( {T}_{n} , {t}_{n} ) , n = 1 , 2 , … N \} ,$$

$${f}_{n} ( {R}_{n} ( U , C , X ) ) ) = {[ \frac{{h}_{n} ( {T}_{n} - {t}_{n} )}{{\sum }_{n = 1}^{N} {h}_{n} ( {T}_{n} - {t}_{n} )} ]}^{- {1}_{{f}_{n} \{ ( {R}_{n} ( U , C , X ) ) < 0 \}}} \times {f}_{n} ( {R}_{n} ( U , C , X ) )$$

where hₙ(·) is a monotonically non-decreasing function depending on operational sensitivities to the target given to the optimizer n. Thus, the allocation adjuster 138 adjusts the allocation to obtain an updated allocation based on a target parameter and a current parameter of the corresponding performance parameter associated with a respective category of content of the plurality of categories of content. In some embodiments, the output of the allocation adjuster 138 is provided to a content item selector 140 to select an optimized content item from the category of content having a highest updated allocation (e.g., corresponding to a winning allocation such as a winning bid) for a respective content item slot on the content page. Further details of the content item selector 140 are provided with respect to FIG. 3. The information from the arbitrator 130 is then provided to an interface generator 144 to automatically generate user interface that displays the selected content item. User interactions (e.g., clicks, dismissals, or other interactions) with the generated user interface provides feedback data 145 is provided to the arbitrator 130 to help tune model parameters of a reinforcement learning model that is used to increase the current parameter (e.g., CTR, conversion, or another performance objective) associated with the category of content. In some embodiments, the content item selection computing device 102 identifies, via the arbitrator 130, an optimal action given the state (e.g., based on features of the user and the context state of the user). For example, the content item selection system identifies objectives to optimize for based on information about the user and on target objectives (e.g., associated with goals of the content display environment, such as business goals or other operational goals). In some embodiments, the content item selection system maps, via the arbitrator 130, a respective user (e.g., a visitor to a webpage) to one or more actions to predict the best action to undertake (e.g., what type of content items to display at which position within a webpage). In some embodiments, after the user features, context information, and the candidate content items are used to predict the best action, the content item selection system ranks and selects specific content items to be displayed for a selected type of content items.

In some embodiments, the arbitrator 130 may be utilized at different points of interactions with a user. For example, the arbitrator 130 may be used to allocate content item slots in an email, in push notifications, on a webpage, on a search results page, a content page, a top page, an item page, a page that is after add-to-cart, a page of the current cart, a checkout page, a thank you page, on a text-to-shop interface, an augmented reality/virtual reality interface, a voice interface, a store page, a accounts page, and/or other communication channels.

FIG. 2 is a block diagram of two example content layouts in accordance with some embodiments. A first example content layout 200 includes a first content item slot 202, a second content item slot 204, a third content item slot 206, and a fourth content item slot 208. In some embodiments, the first content item slot 202, the second content item slot 204, the third content item slot 206, and the fourth content item slot 208 are above the fold (also referred to as “ATF”) such that content items in these content item slots are displayed to the user accessing the content page, without the user having to scroll or otherwise interact with the content page. The first example content layout 200 also includes a fifth content item slot 212, a sixth content item slot 214, a seventh content item slot 216, and an eighth content item slot 218 that are below the fold (also referred to as “BTF”). Content items that are presented below the fold are presented to the user in response to the user scrolling down or otherwise interacting with a lower portion of the content page. In some embodiments, the content page having the first example content layout 200 may be an item page. The content item slots (e.g., the first content item slot 202 through the eighth content item slot 218) may correspond to one or more of the following: an item image (e.g., one or more item images of the item), an item title (e.g., a full title or a short title for the item), a default offer, a “more seller options” user interface element, an item description section (e.g., a detailed description of various features about the item), item recommendations, sponsored items, revenue generating content items (e.g., advertisement, and/or sponsored advertisements), ratings and reviews, and comparison charts.

In some embodiments, the content items on the content page may be arranged in a second example layout 210. The second example layout includes a first content item slot 220, a second content item slot 222, and a third content item slot 224 that are above the fold, and a fourth content item slot 226, a fifth content item slot 228, a sixth content item slot 230, and a seventh content item slot 232 that are below the fold.

In some embodiments, the content page may be a home page, an item page, a search page, a browse page, a list of personalized carousels, a list of user selected items, or a list of user related items. In some embodiments, the content page is a homepage that includes one or more item carousels, banners, grid of different departments available on the content display system, revenue-generating content items (e.g., advertisements, and/or sponsored advertisements), modules of different collections of items, items displayed in a grid, or items that span across a width of the content page (e.g., the first content item slot 220).

FIG. 3 shows an example system 300 that includes an arbitrator 318, in accordance with some embodiments. The system 300 may be implemented by a processor-based computing device, such as the content item selection computing device 102 illustrated in FIG. 1. In some embodiments, user information 302 is used to derive user features 308. User information 302 may include membership information 304 and/or user characteristics 306. For example, the user features 308 may be extracted from the membership information 304 and/or the user characteristics. In some embodiments, membership information 304 may include information about a membership state of a user for an enrollment program (e.g., whether the user is a subscriber of the enrollment program associated with the content display system) that provides one or more benefits to a user. The membership information 304 may include information about the types and frequencies of benefits used, a user's affinity for one or more benefits, such as a benefit that relates to streaming services, a benefit that relates to shipping, a benefit that relates to travel, and/or other benefits. The membership information 304 may also include an indication of a likelihood of user disengagement (e.g., disengagement from the content display system, and/or disengagement from the enrollment program). In some embodiments, the user characteristics 306 include past activities of the user on the content display system, including, for example, past activities such as purchases and/or browsing history. The user characteristics 306 also include information or predictions about the user's intents, affinities, and/or persona (e.g., pet owners, car owners, parents, retired, etc.).

In some embodiments, context information 310 is used to derive real-time user features 312. The context information 310 may provide contextual understanding of the user's current interaction with the content display system. For example, the context information 310 may include information about a page type of a content page accessed by the user, a geo-location of the user while accessing information from the content display system, referral performed by or received by the user, a current season associated with the time the user is accessing information from the content display system, information regarding a device and/or a browser with which the user is accessing the content display environment, and/or information about a current activity session (e.g., a browsing session) or previous activity sessions on the content display system.

In some embodiments, a candidate content pool 314 that includes candidate content items belonging to one or more types of content items (e.g., content items associated with the enrollment program, content items associated with items listed on the content display system, content items associated with listing by third-party users of the content display system, content items associates with encouraging the user to join other third-party users in listing items on the content display system). In some embodiments, content items from the candidate content pool 314 are aggregated and/or organized into a content store 316 that provides various candidate content items to an arbitrator 318. The example system 300 also includes a metrics prioritization 320 that include information about rules for displaying the candidate content items. For example, one rule may state that one or more candidate content items are to be presented above the fold, or below the fold. In some embodiments, the metrics prioritization 320 may include information about target performance metrics for multiple different objectives, such as an increase of click-through-rate of a first amount, an increase of a conversion rate of a second amount, revenue of a third amount for displaying specific content items, a bounce rate of lower than a fourth amount, an increase of add-to-cart amount by a fifth amount, and/or other target performance metrics.

In some embodiments, an arbitrator 318 receives the extracted user features 308, the extracted real-time user features 312, the information from the content store 316, and content items directly from the candidate content pool 314, and the performance metrics specified in the metrics prioritization 320. The arbitrator 318 includes a reward inference calculator 322. The reward inference calculator 322 includes multiple optimizers that each calculates a score Rᵢ(U, C, X) for an i-^{th} reward. In some embodiments, the optimizer for calculating with the i-^{th} reward may be associated with increasing user interactions with a displayed content item. For example, the score Rᵢ(U, C, X) may be associated with an increase in user interactions (e.g., a higher score indicates a larger increase in user interactions, such as a click through rate) for a unique user U having both the extracted user features 308, and the real-time user features 312 derived from the context information 310 that is associated with the context X, when content C (e.g., associated with one of a plurality of candidate content items provided to the arbitrator 318 by the content store 316 and/or the candidate content pool 314) is displayed to the user U.

In some embodiments, the metrics prioritization 320 also provides the performance targets and other rules to an objective weight optimizer 328. In some embodiments, the objective weight optimizer 328 enables the system 300 to dynamically adjust to changes in traffic pattern of users visiting the content page and/or the content item pool (e.g., introduced via the candidate content pool 314 and/or the content store 316), in contrast to systems that use static weight multipliers.

In some embodiments, the objective weight optimizer 328 alone or in conjunction with a multi-objective reinforcement learning and optimizer 330 normalizes a predicted metric score for each content item eligible to be placed at a position on the content page (e.g., a webpage, an email, or other types of communication channels) with respect to observed traffic from a previous time interval (e.g., the past x weeks, the past x months, the past x days). In some embodiments, the observed traffic from the previous time interval is consolidated by a reward aggregator 336, and/or the state action reward store 332. For example, for the observed traffic in the past x weeks, for each metric M (e.g., a user interaction metric, such as a click-through rate, or a revenue based metric, such as the amount of revenue received from displaying various content items, such as advertisements, a conversion rate, or a different metric), the objective weight optimizer 328 obtains a predicted score for a content item occupying a position on the page, calculates its mean μ_{M} and standard deviation Σ_{M}. For each candidate content item and for each metric M, the content item selection system (e.g., the reward inference calculator 322) normalizes the score x_{M} to

$${x}_{M}^{′} = \frac{{x}_{M} - {μ}_{M}}{{\sum }_{M}} .$$

In some embodiments, the normalization of the score dynamically adjusts the score for the traffic flow and the content item pool.

In some embodiments, to align the normalized scores with target objectives (e.g., provided via the metrics prioritization 320), the objective weight optimizer 328 multiplies the normalizes score x′_{M} with an adaptive weight calculated as:

w_{M}=g(β_{M}×(T_{M}−t_{M})

where T_{M} is a current objective target for metric M (on an aggregated user level) obtained from the metric prioritization 320, t_{M} is a current aggregated metric M such that T_{M}−t_{M} is a current gap between the current aggregated metric M from the objective target. β_{M} is a sensitivity parameter associated with the objective target, g(·) is an increasing function that can be selected to cause a quicker or a slower adjustment of the weight w_{M} based on the current gap between the current aggregated metric M from the objective target.

In some embodiments, the weight w_{M} calculated by the objective weight optimizer 328 can dynamically detect, for any metric M, if the current gap between the current aggregated metric M from the objective target is relatively larger compared to other metrics. In some embodiments, by the objective weight optimizer 328 increases the respective weights w_{M} for metrics having larger current gaps to increase a likelihood that content items which are better able to increase those metrics are selected. In some embodiments, the objective weight optimizer 328 normalizes the weight w_{M} to

$${w}_{M}^{′} = \frac{{w}_{M}}{{\sum }_{{M}^{′}} {w}_{{M}^{′}}} ,$$

where the denominator sums over all metrics M′ that are balanced by the arbitrator 130. The normalized weights w′_{M} are multiplied with the corresponding normalized predicted score x′_{M}. In some embodiments, for user U having a context X, the content item is picked as C*=argmax_{C}{max_{M}{w′_{M}×x′_{M} (U, C, X)}}, where C loops through all candidate content item for a particular slot.

In some embodiments, the multi-objective reinforcement learning and optimizer 330 automatically boosts content items to promote a metric M which has a relatively higher lag from its target (e.g., w′_{M} keeps increasing depending on the current gap between the current metric M from the objective target for the current content item pool and the current traffic pattern. Some objective metrics may be correlated (e.g., strongly correlated), and a particular content item may increase multiple metrics, whereas other content items may only increase a single metric. In some embodiments, due to the choice of optimizing function (e.g., max_{M}(·)) for selecting content item, the arbitrator 130 may not be biased towards selecting content items that increase multiple metrics at the cost of content items that increase only a subset of metrics (e.g., a single metric or a few metrics). In contrast, a function that sums w′_{M}×x′_{M}(U, C, X) instead of selecting the maximum (e.g., max_{M}(·)) may be more likely to be biased towards content items that increase multiple metrics.

In some embodiments, the multi-objective reinforcement learning and optimizer 330 receives input, via the state action reward store 332, about a reward resulting from an action taken (e.g., after an optimized content item type selected by a layout optimizer 324 and an optimized content item is selected by a content selector 326, and presented at an optimized location to the user) and the computer system continuously tunes model parameters to improve one or more selected metrics (e.g., one or more objective metrics specified by the metrics prioritization 320). In some embodiments, the state action reward store 332 receives and stores reward information received the reward aggregator 336. In some embodiments, the reward aggregator 336 in turns receives performance data 342 derived from actual (e.g., real-time) user interaction based on content items displayed on a user interface 340. In some embodiments, the performance data 342 measure a change (e.g., an increase or a decrease) in one or more of: a bounce rate, an amount of user engagement, repeat engagement, number of add-to-cart, conversion, gross value of merchandise, cross sell, cross pollination, revenue from displaying content items, retention, lifetime value, or another metric. In some embodiments, the multi-objective reinforcement learning and optimizer 330 or another component of the system 300 allows manual intervention/control to accelerate or slow down a pace at which an operational target or goal (e.g., a business goal or another objective) is reached. In some embodiments, the multi-objective reinforcement learning and optimizer 330 or another component of the system 300 performs reward prediction by predicting a likelihood that a user, having a particular user state associated with the user features 308, engages with a given set of content items (e.g., ordering the presentation of content items, or organized groups of content items in a module ordering) from the content store 316 to yield the highest reward as calculated by the reward inference calculator 322 of the arbitrator 318, or another component of the system 300. In some embodiments, the arbitrator 130 performs contextual explore and/or exploit to further maximize a reward from the reward inference calculator 322. In some embodiments, the multi-objective reinforcement learning and optimizer 330 performs multi-objective optimization by refining one or more optimization function and weights used for those functions to achieve the goals specified in the metrics prioritization 320. In some embodiments, reinforcement learning does not use labeled data as training data sets, instead, the metrics prioritization 320 stores one or more desired results (e.g., target objectives). In some embodiments, the training of the reinforcement learning models includes mapping inputs (e.g., user features 308, context information 310, and/or content from the content store 316) to possible outcomes (e.g., changes in user interaction such as click-through weights, changes in conversion, and/or changes in revenue). In some embodiments, weights for the optimization functions in the reinforcement learning models that yield the best outcomes (e.g., closes to those specified by the metrics prioritization 320) are adjusted to reward outcomes that correspond to the goals specified in the metrics prioritization 320. In some embodiments, the multi-objective reinforcement learning and optimizer 330 provides feedback to the arbitrator 318. For example, for each impression of a content item (e.g., when the content item is present to the user), the multi-objective reinforcement learning and optimizer 330 may provide feedback to the arbitrator 318 regarding whether the presented content item is relevant or engaging to the user, determined based on the performance data 342.

In some embodiments, the arbitrator 318 includes a layout optimizer 324. In some embodiments, the layout of a content page (e.g., a webpage, or email, or another page of a communication channel) can be adaptive to each user's needs based on user behavior, and optimized according to one or more metrics. For example, the layout optimizer 324 can select an optimized layout for an item page from among different layouts (e.g. different content items and/or different spatial arrangements of content items) for a particular user, based on the user features 308, the real-time user features 312 (e.g., including the context information 310) and information about a content item from the content store 316. In some embodiments, the layout optimizer 324 may provide a layout that is more accurately tailored to the user's interests and may provide a presentation of content items that is more relevant to the user, compared to using a default layout for all users regardless of their different user features and context information. For example, if a user lands on an item page for the first time before exploring any other items, the item page may be displayed with a first layout that focuses more on information of the item than providing more recommendation elements. In another example, if a user lands on the item page for the second or third time after exploring multiple similar items, the item page may be displayed with a second layout that focuses more on comparing the item with other items.

In some embodiments, the layout optimizer 324 may assess an impact of each content item on each of a plurality of target metrics provided by the metrics prioritization 320, based on the context information 310, and/or the user features 308 (e.g., based on outputs from the reward inference calculator 322). In some embodiments, the arbitrator 318 may balance between competing metrics specified in the metrics prioritization 320 to optimize the layout of a content page.

In some examples, the system may generate weights based on the determined context and element impact data, and generate a reward score for each page element by combining metric scores of the element regarding different metrics with the generated weights. The system may then determine a webpage layout based on the elements and their reward scores, and create or update the webpage according to the determined layout. In some embodiments, the layout optimizer 324 provides a dynamic content page layout optimization which is robust to changes in user behavior (e.g., an updated amount of use of a page element), the reward inference calculator 322 can generate an updated reward score for at least one content item and determine an updated layout of the webpage based on the updated reward score. For example, the content page may be updated automatically and dynamically by moving the at least one content item to a new position on the content page according to the optimized layout. In some embodiments, the layout optimizer 324 may determine one or more layout features including a position, a size, a shape or a color of a selected content item.

In some embodiments, the output from the layout optimizer 324 is provided to the content selector 326 to select content items for each type of content items identified by the layout optimizer 324 for display at locations on a content page identified by the layout optimizer 324. In some embodiments, the content C* chosen by the content selector 326 for a particular content slot may be

C*=argmax_{c}maxₙdₙ(U,C,X)

where dₙ(U, C, X) is an adjusted bid on the content item C as defined in paragraph [0040].

In some embodiments, when the content selector 326 is activated to select content for a particular content slot, the user U, and the context X may already be determined (e.g., by the user features 308 and the content store 316), thus only dₙ(U, C, X) values corresponding to the respective U and X are considered. In some embodiments, when the content selector 326 selects content for k content slots from the same pool of candidate, the content selector 326 may select the top k content items using the following:

$${C}_{1}^{*} , {C}_{2}^{*} … , {C}_{k}^{*} = top k$$

content items from a sorted list of C in order of maxₙdₙ(U, C, X).

In some embodiments, when choosing content items for multiple slots, the arbitrator 318 (e.g., the content selector 326) is likely to distribute the slots to different optimizers, providing a balance among different objectives, unless gaps from the specific targets (e.g., targets for specific objectives) are unusually skewed. In some embodiments, a content slot is allocated to an optimizer j if for the allocated content C*, the adjusted allocation is the highest for the optimizer j. In other words, j=argmaxₙdₙ(U, C*, X).

In some embodiments, the output of the arbitrator 318 is provided to a user interface generator (e.g., the interface generator 144 described with respect to FIG. 1) to generate a user interface 340 that displays the content items selected by the content selector 326 using the layout determined by the layout optimizer 324. In some embodiments, the output of the arbitrator 318 is also provided to a server-side feedback collector 338. In some embodiments, the server-side feedback collector 338 reports to a content server associated with the content-display system (e.g., in contrast to reports generated by a user's device, or a client-side report) on a consumption statistics associated with a content item (e.g., by sending beacons to the content server associated with the content display system at a start of a clip associated with a content item, and at predefined portions of the clip associated with the content item) to provide feedback if a user has viewed and/or interacted with the content item. In some embodiments, the output of the server-side feedback collector 338 is provided to the rewards aggregator 336 to evaluate the content item selected for display by the arbitrator 318. In some embodiments, the reward aggregator 336 consolidates the input from the server-side feedback collector 338 and the performance data 342 derived from user interactions with the user interface 340 to determine an actual outcome (e.g., an amount of user interface, an amount of conversion, an amount of conversion, and/or another metric) associated with displaying a respective content item C to the user U, under context X. In some embodiments, the system 300 may provide an optimal experience with the arbitrator 318 that maximizes rewards (e.g., calculated by the reward inference calculator 322). In some embodiments, a final reward for each type of content items displayed on the content page is calculated based on the user state (e.g., specified by the user features 308) and the position determined by the layout optimizer 324 at which the content item is presented to the user. In some embodiments, a cumulative reward having the highest values determines the selected layout. For example, the selected layout has a cumulative reward that is higher than a default layout.

In some embodiments, the system 300 implements a method of rearranging content items on a graphical user interface (GUI) of a computer system. In some embodiments, the method includes receiving, via the GUI (e.g., the user interface 340), a user input requesting a display of a content page (e.g., a user selection to organize candidate content items based on a specific criteria, wherein the specific criteria is an amount of relevance of the candidate content items to the user, based on at least one of user features or context information). The method includes determining, by a processor (e.g., the system 300, or the arbitrator 318), a reward score associated with displaying a content item at a predefined position on the content page (e.g., based on a predicted relevance of a content item to the user over a predetermined period of time); and automatically moving the most relevant content item to the predefined position on the content page based on the reward score. In some embodiments, the system automatically presents an optimized set of content items based on an optimized layout to the user based on a set of predefined criteria (e.g., specified in the metrics prioritization 320), which provides a specific improvement over prior systems, resulting in an improved user interface for electronic devices that automatically balances a set of displayed content items among competing objectives for different types of content items.

In some embodiments, the output of the reward aggregator 336 is provided, in addition to the objective weight optimizer 328, to a metrics dashboard 334 that provides a summary of the arbitrator 318 performance metrics and explanations of why certain content items were selected. In some embodiments, the metrics dashboard 334 provides an indication of how performance metrics are changed (e.g., increased or decreased) by the display of the selected content items.

In some embodiments, the system 300 implements a method of training a reinforcement learning model for balancing between multiple objectives specified in the metric prioritization 320. The method includes collecting a set of user features (e.g., the user features 308), contextual information (e.g., context information 310) from a database (e.g., a database storing the user features, and/or a database storing real-time user features 312), and content items (e.g., from the content store 316). The method includes calculating a score Rᵢ(U, C, X) based on user features, contextual information, and content item. The method includes applying one or more transformations to the calculated score Rᵢ(U, C, X) to create a modified set of scores that corresponds to an allocation ƒᵢ(Rᵢ(U, C, X)). The method includes creating a first set of mapping that maps a set of input that includes the user features, contextual information and the content item, to a set of output that includes one or more target performance metrics (e.g., specified in the metrics prioritization 320), the modified set of scores that corresponds to the allocation, and a set of distribution for the allocation; training the reinforcement learning model in a first stage using the first set of mapping and the modified set of scores that corresponds to the allocation; creating a second set of mappings for a second stage of training comprising the first set of mapping, the modified set of scores that corresponds to the allocation, and the feedback derived from the presentation of content items based on the modified set of scores, and updating weights associated with optimization functions associated with the reinforcement learning model; and training the neural network in a second stage using the second set of mapping based on the updated weights for the optimization functions associated with the reinforcement learning model.

In some embodiments, the content item selection system provides outputs that achieves multi-objective optimization, are fair and unbiased, scalable, consistent across different communication channels (e.g., webpage and email), are relevant while meeting operational constraints, are user and context aware, allow tracking and measurement by providing explainability and accountability.

The task of identifying relevant content items to be displayed to a user in an optimized layout can be burdensome and time consuming. Typically, a user can locate information regarding various content items by navigating a browse structure, sometimes referred to as a “browse tree,” in which interface pages or elements are arranged in a predetermined hierarchy. Such browse trees typically include multiple hierarchical levels, requiring users to navigate through several levels of browse nodes or pages to arrive at an interface page or content item of interest. Thus, the user may have to perform numerous navigational steps frequently to arrive at a page containing information regarding content items. Systems including the arbitration system, reinforcement learning model and trained ranking models, as disclosed herein, significantly reduce this problem, enabling users to be presented with selected content items in an optimized layout format with fewer, or in some cases, no active steps. Each content item may serve as a programmatically selected navigational shortcut to an interface page, enabling a user to bypass the navigational structure of the browse tree. Beneficially, programmatically identifying content items of interest and presenting a user with navigation shortcuts to these items can improve the speed of the user's navigation through an electronic interface, rather than requiring the user to page through multiple other pages to locate information about various content items via the browse tree or via a search function. This can be particularly beneficial for computing devices with small screens, where fewer interface elements can be displayed to a user at a time and, thus, navigation of larger volumes of data is more difficult.

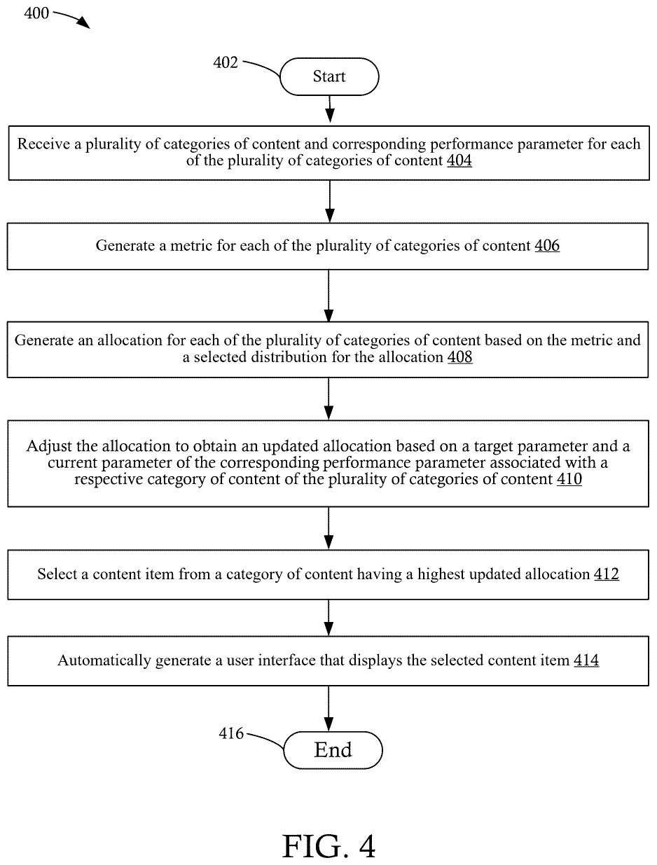

FIG. 4 is a flow diagram depicting an example arbitration method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or repeat. In some implementations, blocks of the method may be combined.

The method shown in FIG. 4 may be implemented in the form of executable instructions stored on machine-readable media and executed by a processing resource and/or in the form of electronic circuitry. For example, aspects of the methods may be described below as being performed by a content item selection system, an example of which may be the method 400 running on a hardware processing resource 104 of the content item selection computing device 102 described above. Additionally, other aspects of the methods described below may be described with reference to other elements shown in FIG. 1 for non-limiting illustration purposes.

FIG. 4 depicts a flow diagram illustrating a method 400 of content item selection, in accordance with some embodiments. Method 400 starts at block 402 and continues to block 404, where a plurality of categories of content for display in a network environment and a corresponding performance parameter for each of the plurality of categories of content within the network environment may be received to arbitrate one or more content items from the plurality of categories of content to be displayed in the network environment. For example, the plurality of categories of content may include content items corresponding to different business objectives, such as a third-party ecommerce platform, advertising revenue, and/or an enrollment program that provides benefits to users. As another example, the corresponding performance parameter may correspond to a characteristic to optimize for, such as optimize add to cart, optimize click through rates. At block 406, a metric (e.g., a raw score of a reward Rᵢ(U,C,X), based on user U, content C, and context X) for each of the plurality of categories of content is generated.

At block 408, an allocation (e.g., the allocation generator 134 converts raw scores to an allocation or a bid) for each of the plurality of categories of content based on the metric and a selected distribution for the allocation (e.g., a standard normal distribution, or a different distribution function) is generated.

At block 410, the allocation to obtain an updated allocation based on a target parameter (e.g., the performance target for the category of content) and a current parameter (e.g., a current attainment for the category of content) of the corresponding performance parameter associated with a respective category of content of the plurality of categories of content is adjusted.

At block 412, a content item from a category of content having a highest updated allocation is selected by arbitrating based on updated allocations of the one or more content items from the plurality of categories of content. At block 414, a user interface that displays the selected content item within the network environment is automatically generated. At block 416, the method 400 ends.

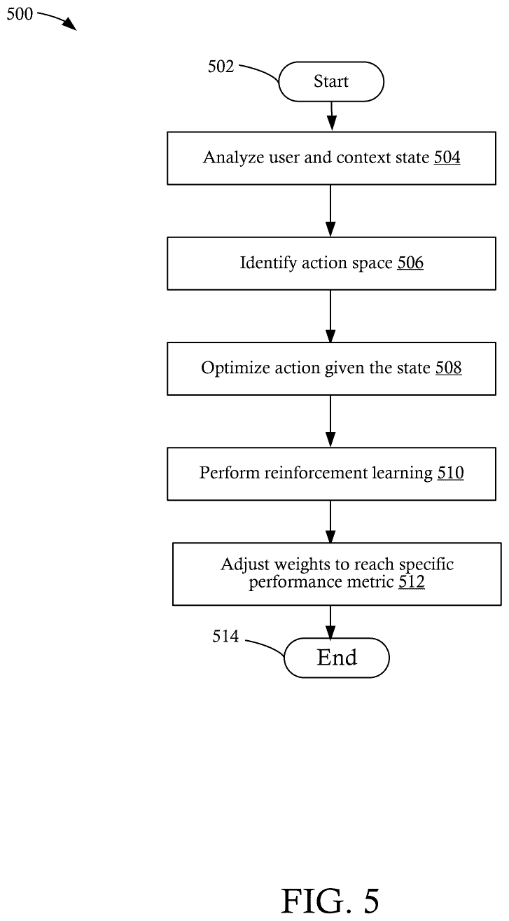

FIG. 5 is a flow diagram depicting an example method. In some embodiments, one or more blocks of the method may be executed substantially concurrently and/or in a different order than shown. In some implementations, a method may include more or fewer blocks than are shown. In some implementations, one or more of the blocks of a method may, at certain times, be ongoing and/or repeat. In some implementations, blocks of the method may be combined.

The method shown in FIG. 5 may be implemented in the form of executable instructions stored on machine-readable media and executed by a processing resource and/or in the form of electronic circuitry. For example, aspects of the methods may be described below as being performed by a content item selection system, an example of which may be the method 500 running on a hardware processing resource 104 of the content item selection computing device 102 described above. Additionally, other aspects of the methods described below may be described with reference to other elements shown in FIG. 1 for non-limiting illustration purposes.

FIG. 5 depicts a flow diagram illustrating a method 500 of content item selection, in accordance with some embodiments. Method 500 starts at block 502 and continues to block 504, where a user and a context state are analyzed. In some embodiments, the method 500 uses a state, action and reward driven approach to optimize the selection of content items across competing objectives. For example, the content item selection system analyzes a user's interaction within a content display environment. In some embodiments, the method 500 analyzes a user's interaction with the content display environment includes understanding a user's journey (e.g., the user's prior interactions with the content display environment, or a chronology of the user's prior interactions with one or more webpages or applications, and/or operations performed by the user in the content display environment), and deduces an intent of the user associated with a particular interaction session with the content display environment. At block 506, an action space is identified. In some embodiments, after analyzing and understanding the user, a context state of the user, the heterogeneous content items available for display to the user, the content item selection system identifies an action space that includes possible actions the content item selection system and/or the user can take based on the analysis about features of the user and the context state of the user, improving the relevance of the displayed content items to the user, and may help improve user experience and/or ease of performing various interactions (e.g., transactions) in the network environment.

At block 508, an action is optimized for a given state. At block 510, reinforcement learning is performed based on feedback provided by the user to content items that are displayed on a user interface (e.g., user interface 340 in FIG. 3). The feedback is used to tune model parameters of the reinforcement learning model to increase the current parameter associated with the category of content. At block 512, weights are adjusted to reach a specific performance metric (e.g., weights are adjusted as described with reference to the objective weight optimizer 328 in FIG. 3). At block 514, the method 500 ends.

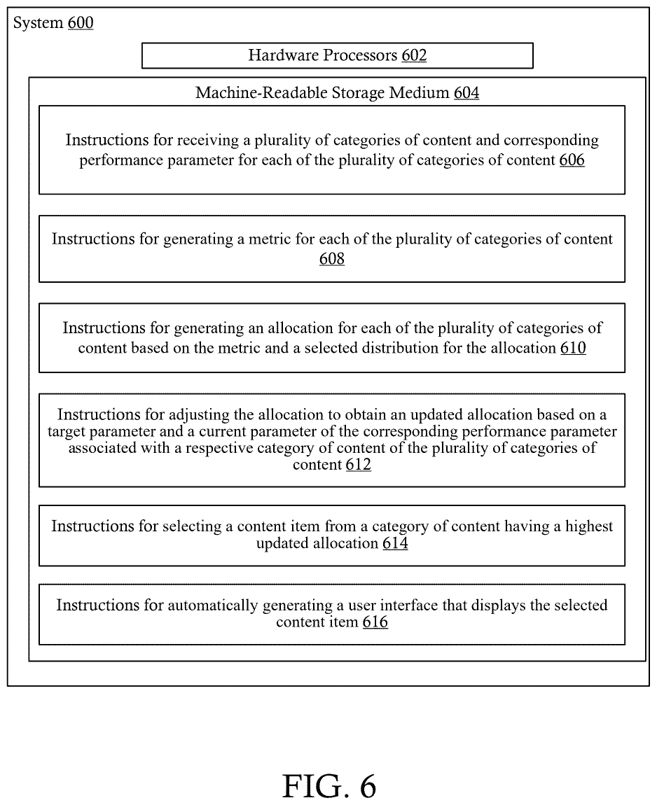

FIG. 6 depicts an example system 600 that includes non-transitory, machine-readable media 604 encoded with example instructions executable by processing resource 602. In some implementations, the system 600 may be useful for implementing aspects of the arbitrator 130 of FIG. 1. For example, the instructions encoded on machine-readable media 604 may be included in instructions 108 of FIG. 1. In some implementations, functionality described with respect to FIG. 1 may be included in the instructions encoded on machine-readable media 604.

The processing resource 602 may include a microcontroller, a microprocessor, central processing unit core(s), an ASIC, an FPGA, and/or other hardware device suitable for retrieval and/or execution of instructions from the machine-readable media 604 to perform functions related to various examples. Additionally, or alternatively, the processing resource 602 may include or be coupled to electronic circuitry or dedicated logic for performing some or all the functionality of the instructions described herein.

The machine-readable media 604 may be any medium suitable for storing executable instructions, such as RAM, ROM, EEPROM, flash memory, a hard disk drive, an optical disc, or the like. In some example implementations, the machine-readable media 604 may be a tangible, non-transitory medium. The machine-readable media 604 may be disposed within the system 600 respectively, in which case the executable instructions may be deemed installed or embedded on the system. Alternatively, the machine-readable media 604 may be a portable (e.g., external) storage medium and may be part of an installation package.

As described further herein below, the machine-readable media 604 may be encoded with a set of executable instructions. Part or all the executable instructions and/or electronic circuits included within one box may, in alternate implementations, be included in a different box shown in the figures or in a different box not shown. Some implementations may include more or fewer instructions than are shown in FIG. 6.

With reference to FIG. 6, the machine-readable media 604 includes instructions 606-616. Instructions 606, when executed, cause the processing resource 602 to receive a plurality of categories of content for display in a network environment and a corresponding performance parameter for each of the plurality of categories of content. Instructions 608, when executed, cause the processing resource 602 to generate a metric for each of the plurality of categories of content within the network environment to arbitrate one or more content items from the plurality of categories of content to be displayed in the network environment.

In accordance with a determination that the similarity score is greater than the first threshold, instructions 610, when executed, cause the processing resource 602 to generate an allocation for each of the plurality of categories of content based on the metric and a selected distribution for the allocation.

Instructions 612, when executed, cause the processing resource 602 to adjust the allocation to obtain an updated allocation based on a target parameter and a current parameter of the corresponding performance parameter associated with a respective category of content of the plurality of categories of content. Instructions 614, when executed, cause the processing resource 602 to select, by arbitrating based on updated allocations of the one or more content items from the plurality of categories of content, a content item from a category of content having a highest updated allocation. Instructions 616, when executed, cause the processing resource 602 to automatically generate a user interface within the network environment that displays the selected content item.

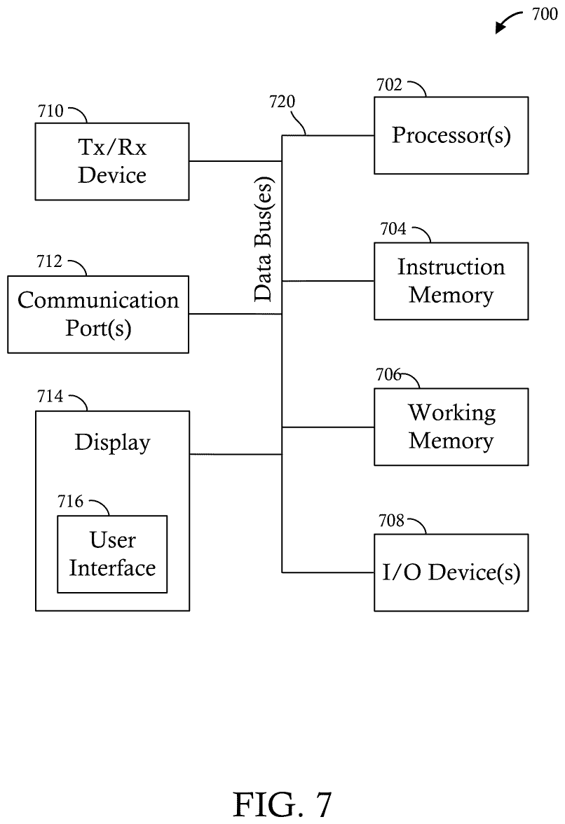

FIG. 7 illustrates a block diagram of a computing device 700, in accordance with some embodiments. Although FIG. 7 is described with respect to certain components shown therein, it will be appreciated that the elements of the computing device 700 may be combined, omitted, and/or replicated. In addition, it will be appreciated that additional elements other than those illustrated in FIG. 7 may be added to the computing device.

As shown in FIG. 7, the computing device 700 may include one or more processing resources 702, instruction memory 704, working memory 706, one or more input/output devices 708, transceiver 710, communication ports 712, display 714, and/or any other suitable elements each operatively coupled to one or more data buses 720. The data buses 720 enable communication among the various components. The data buses 720 may include wired, or wireless, communication channels.

The one or more processing resources 702 may include any processing circuitry operable to control operations of the computing device 700. In some embodiments, the one or more processing resources 702 include one or more distinct processors, each having one or more cores (e.g., processing circuits). Each of the distinct processors may have the same or different structure. The one or more processing resources 702 may include one or more central processing units (CPUs), one or more graphics processing units (GPUs), ASICs, digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processing resources 702 may also be implemented by a controller, a microcontroller, an ASIC, an FPGA, a programmable logic device (PLD), etc.

In some embodiments, the one or more processing resources 702 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 704 may store instructions that are accessed (e.g., read) and executed by at least one of the one or more processing resources 702. For example, the instruction memory 704 may be a non-transitory, computer-readable storage medium such as a ROM, an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processing resources 702 may perform a certain function or operation by executing code, stored on the instruction memory 704, embodying the function or operation. For example, one or more processing resources 702 may execute code stored in the instruction memory 704 to perform one or more of any function, method, or operation disclosed herein.

Additionally, the one or more processing resources 702 may store data to, and read data from, the working memory 706. For example, one or more processing resources 702 may store a working set of instructions to the working memory 706, such as instructions loaded from the instruction memory 704. The one or more processing resources 702 may also use the working memory 706 to store dynamic data created during one or more operations. The working memory 706 may include, for example, RAM such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), CAM, polymer memory (e.g., ferroelectric polymer memory), phase-change memory (e.g., ovonic memory), ferroelectric memory, SONOS memory, a removable disk, CD-ROM, any non-volatile memory, or any other suitable memory. Although embodiments are illustrated herein including separate instruction memory 704 and working memory 706, it will be appreciated that the computing device 700 may include a single memory unit that operates as both instruction memory and working memory. Further, although embodiments are discussed herein including non-volatile memory, it will be appreciated that computing device 700 may include volatile memory components in addition to at least one non-volatile memory component.

In some embodiments, the instruction memory 704 and/or the working memory 706 includes an instruction set, in the form of a file for executing various methods, such as methods for generating an interface based on location data and resource use probability, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments a compiler or interpreter converts the instruction set into machine executable code for execution by the one or more processing resources 702.

The input/output devices 708 may include any suitable device that enables data input or output. For example, the input/output devices 708 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 710 and/or the communication port(s) 712 enable communication with a network. For example, if a communication network is a cellular network, the transceiver 710 allows communications with the cellular network. In some embodiments, the transceiver 710 is selected based on the type of the communication network the computing device 700 will be operating in. The one or more processing resources 702 are operable to receive data from, or send data to, a network, via the transceiver 710.

The communication port(s) 712 may include any suitable hardware, software, and/or combination of hardware and software capable of coupling the computing device 700 to one or more networks and/or additional devices. The communication port(s) 712 may be arranged to operate with any suitable technique for controlling information signals using a desired set of communications protocols, services, or operating procedures. The communication port(s) 712 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 712 enables the programming of executable instructions in instruction memory 704. In some embodiments, the communication port(s) 712 enable(s) the transfer (e.g., uploading or downloading) of data, such as machine learning model training data.

In some embodiments, the communication port(s) 712 couples the computing device 700 to a network. The network may include local area networks (LAN) as well as wide area networks (WAN) including without limitation internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 710 and/or the communication port(s) 712 utilize one or more communication protocols. Examples of wired protocols may include, but are not limited to, USB communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 902.xx series of protocols, such as IEEE 702.11a/b/g/n/ac/ag/ax/be, IEEE 702.16, IEEE 902.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 714 may be any suitable display and may display the user interface 716. The user interface 716 may enable user interaction with interface elements representative of an arbitrator 130. For example, the user interface 716 may be a user interface for an application of a network environment operator that enables a user to view and interact with the operator's website. In some embodiments, a user may interact with the user interface 716 by engaging the input/output devices 708. In some embodiments, the display 714 may be a touchscreen, where the user interface 716 is displayed on the touchscreen.

The display 714 may include a screen such as, for example, a Liquid Crystal Display (LCD) screen, a light-emitting diode (LED) screen, an organic LED (OLED) screen, a movable display, a projection, etc. In some embodiments, the display 714 may include a coder/decoder, also known as Codecs, to convert digital media data into analog signals. For example, the visual peripheral output device may include video Codecs, audio Codecs, or any other suitable type of Codec.

In some embodiments, the computing device 700 implements one or more modules or engines, each of which is constructed, programmed, configured, or otherwise adapted, to autonomously carry out a function or set of functions. A module/engine may include a component or arrangement of components implemented using hardware, such as by an ASIC or FPGA, for example, or as a combination of hardware and software, such as by a microprocessor system and a set of program instructions that adapt the module/engine to implement the particular functionality that (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices) that execute an operating system, system programs, and application programs, while also implementing the engine using multitasking, multithreading, distributed (e.g., cluster, peer-peer, cloud) processing where appropriate, or other such techniques. Accordingly, each module/engine may be realized in a variety of physically realizable configurations and should generally not be limited to any particular example implementation herein, unless such limitations are expressly called out. In addition, a module/engine may itself be composed of more than one sub-module or sub-engine, each of which may be regarded as a module/engine in its own right. Moreover, in the embodiments described herein, each of the various modules/engines corresponds to a defined autonomous functionality; however, in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

In some embodiments, the computing device 700 may be a computer, a workstation, a laptop, a server such as a cloud-based server, or any other suitable device. In some embodiments, the computing device 700 is a server that includes one or more processing units, such as one or more GPUs, one or more CPUs, and/or one or more processing cores. The computing device 700 may, in some embodiments, execute one or more virtual machines. In some embodiments, processing resources (e.g., capabilities) of the computing device 700 are offered as a cloud-based service (e.g., cloud computing).

Although embodiments are illustrated herein including certain systems and/or devices, it will be appreciated that additional systems, servers, storage mechanisms, etc. may be included. In addition, although embodiments are illustrated herein having individual, discrete systems, it will be appreciated that, in some embodiments, one or more systems may be combined into a single logical and/or physical system. Similarly, although embodiments are illustrated having a single instance of each device or system, it will be appreciated that additional instances of a device may be implemented. In some embodiments, two or more systems may be operated on shared hardware in which each system operates as a separate, discrete system utilizing the shared hardware, for example, according to one or more virtualization schemes.

Although the subject matter has been described in terms of example embodiments, it is not limited thereto. Rather, the appended claims should be construed broadly, to include other variants and embodiments that may be made by those skilled in the art.

What is claimed is:

1. A system, comprising:
a processor; and
a non-transitory memory storing instructions, that when executed, cause the processor to:
receive a plurality of categories of content for display in a network environment and a corresponding performance parameter for each of the plurality of categories of content within the network environment to arbitrate one or more content items from the plurality of categories of content to be displayed in the network environment;
generate a metric for each of the plurality of categories of content;
generate an allocation for each of the plurality of categories of content based on the metric and a selected distribution for the allocation;
adjust the allocation to obtain an updated allocation based on a target parameter and a current parameter of the corresponding performance parameter associated with a respective category of content of the plurality of categories of content;
select, by arbitrating based on updated allocations of the one or more content items from the plurality of categories of content, a content item from a category of content having a highest updated allocation; and
automatically generate a user interface within the network environment that displays the selected content item.

2. The system of claim 1, wherein generating the metric comprises generating a score based on one or more user characteristics and a context for each of the plurality of categories of content.

3. The system of claim 1, wherein adjusting the allocation to obtain the updated allocation comprises accounting for an aggregated target parameter associated with a target parameter for each of the plurality of categories of content.

4. The system of claim 1, wherein the instructions, when executed, further cause the processor to:
detect a change in user interaction in response to displaying the selected content item; and
tune model parameters of a reinforcement learning model to increase the current parameter associated with a category of content.

5. The system of claim 1, wherein the selected distribution for the allocation comprises a predefined expectation value for the allocation and a predefined variance for the allocation.

6. The system of claim 1, wherein receiving the plurality of categories of content further comprises receiving candidate content items associated with each category of content in the plurality of categories of content, and selecting the content item from the category of content having the highest updated allocation comprises selecting a content item from the candidate content items associated with the category of content having the highest updated allocation.

7. The system of claim 1, wherein generating the metric for each of the plurality of categories of content and the corresponding performance parameter comprises determining a corresponding normalized performance parameter for a candidate content item associated with a respective category of content of the plurality of categories of content.

8. A computer-implemented method, comprising:
receiving a plurality of categories of content for display in a network environment and a corresponding performance parameter for each of the plurality of categories of content within the network environment to arbitrate one or more content items from the plurality of categories of content to be displayed in the network environment;
generating a metric for each of the plurality of categories of content;
generating an allocation for each of the plurality of categories of content based on the metric and a selected distribution for the allocation;
adjusting the allocation to obtain an updated allocation based on a target parameter and a current parameter of the corresponding performance parameter associated with a respective category of content of the plurality of categories of content;
selecting, by arbitrating based on updated allocations of the one or more content items from the plurality of categories of content, a content item from a category of content having a highest updated allocation; and
automatically generating a user interface within the network environment that displays the selected content item.

9. The computer-implemented method of claim 8, wherein generating the metric comprises generating a score based on one or more user characteristics and a context for each of the plurality of categories of content.

10. The computer-implemented method of claim 8, wherein adjusting the allocation to obtain the updated allocation comprises accounting for an aggregated target parameter associated with a target parameter for each of the plurality of categories of content.

11. The computer-implemented method of claim 8, further comprising:
detecting a change in user interaction in response to displaying the selected content item; and
tuning model parameters of a reinforcement learning model to increase the current parameter associated with a category of content.

12. The computer-implemented method of claim 8, wherein the selected distribution for the allocation comprises a predefined expectation value for the allocation and a predefined variance for the allocation.

13. The computer-implemented method of claim 8, wherein receiving the plurality of categories of content further comprises receiving candidate content items associated with each category of content in the plurality of categories of content, and selecting the content item from the category of content having the highest updated allocation comprises selecting a content item from the candidate content items associated with the category of content having the highest updated allocation.

14. The computer-implemented method of claim 8, wherein generating the metric for each of the plurality of categories of content and the corresponding performance parameter comprises determining a corresponding normalized performance parameter for a candidate content item associated with a respective category of content of the plurality of categories of content.

15. A non-transitory computer readable medium having instructions stored thereon, wherein the instructions, when executed by at least one processor, cause at least one device to perform operations comprising:
receiving a plurality of categories of content for display in a network environment and a corresponding performance parameter for each of the plurality of categories of content within the network environment to arbitrate one or more content items from the plurality of categories of content to be displayed in the network environment;
generating a metric for each of the plurality of categories of content;
generating an allocation for each of the plurality of categories of content based on the metric and a selected distribution for the allocation;
adjusting the allocation to obtain an updated allocation based on a target parameter and a current parameter of the corresponding performance parameter associated with a respective category of content of the plurality of categories of content;
selecting, by arbitrating based on updated allocations of the one or more content items from the plurality of categories of content, a content item from a category of content having a highest updated allocation; and
automatically generating a user interface within the network environment that displays the selected content item.

16. The non-transitory computer readable medium of claim 15, wherein generating the metric comprises generating a score based on one or more user characteristics and a context for each of the plurality of categories of content.

17. The non-transitory computer readable medium of claim 15, wherein adjusting the allocation to obtain the updated allocation comprises accounting for an aggregated target parameter associated with a target parameter for each of the plurality of categories of content.

18. The non-transitory computer readable medium of claim 15, wherein the selected distribution for the allocation comprises a predefined expectation value for the allocation and a predefined variance for the allocation.

19. The non-transitory computer readable medium of claim 15, wherein receiving the plurality of categories of content further comprises receiving candidate content items associated with each category of content in the plurality of categories of content, and selecting the content item from the category of content having the highest updated allocation comprises selecting a content item from the candidate content items associated with the category of content having the highest updated allocation.

20. The non-transitory computer readable medium of claim 15, wherein generating the metric for each of the plurality of categories of content and the corresponding performance parameter comprises determining a corresponding normalized performance parameter for a candidate content item associated with a respective category of content of the plurality of categories of content.
